(19) United States
(12) Patent Application Publication
(10) Pub. No.: US 2002/0087604 A1
(43) Pub. Date: Jul. 4, 2002

(54) Method and system for intelligent spellchecking

(75) Inventors: Arendse Bernth, Ossining, NY (US); Michael Campbell McCord, Ossining, NY (US)

Correspondence Address: MCGINN & GIBB, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 09/753,547

(22) Filed: Jan. 4, 2001

(51) Int. Cl. G06F 17/24

(52) U.S. Cl. 707/533

(57) ABSTRACT

A method (and system) for intelligent spellchecking, includes performing a spellchecking of a word by considering an entire sentence and a structure of the entire sentence, in determining whether the word is misspelled.

### BACKGROUND OF THE INVENTION

1. Field of the Invention

The present invention generally relates to a method and system for spellchecking, and more particularly to a method and system for intelligent spellchecking in which words are examined for misspelling absolutely and in terms of their context within a sentence.

2. Description of the Related Art

Traditional spellcheckers work by looking up words in dictionaries. If the word is not found in any of the system or user-supplied dictionaries, it is considered a misspelled word (see, for example, U.S. Pat. Nos. 4,775,251, 4,980,855, 4,915,546, and 4,383,307, etc., which all presuppose this method of identifying misspelled words).

Clearly, this method does not cover identification of words that are correct English words, but which are wrong in context. An example of this problem is “the sea is blew”, where “blew ” is a valid English word, but obviously a misspelling of “blue ” (i.e., the intended meaning).

U.S. Pat. No. 4,868,750 indirectly addresses this issue, by using a statistical method to look at pairs of words to reduce the number of possible parts-of-speech and morphosyntactic features assigned to each word as a preprocessing step to parsing.

Then, a substitute calculation reveals erroneous uses of valid English words for listed pairs of commonly confused words. This operation occurs during the statistical processing of collocational pairs, where a “collocational ” pair is a set of two words that occur together with a special meaning (e.g., “down time ”).

This method takes advantage of the existing setup (e.g., the statistical parsing method etc. described in the above-mentioned U.S. Pat. No. 4,868,750) for reducing the number of tags (e.g., parts of speech, nouns, verbs, etc., and morphosyntactic features) assigned to each word by looking for a better “fit” for a potentially misspelled word. For example, words which end in “s” may indicate merely that the word could be used only as a plural noun or as a singular verb.

Thus, for example, if a word such as “features ” is considered, a morphological analysis of the word “features ” would indicate two tags present, one tag being for the word being used as a singular verb and another tag indicating use of the word as a plural noun.

However, a weakness of the above-described conventional method is that the context that is used to identify potential misspellings is very small. That is, at most only a portion of a phrase or adjacent words are examined for the context of the word. Hence, the sample of words to judge the context of what is meant and what the correct word should be is limited.

However, if the entire sentence and the structure of the entire sentence are taken into consideration, much better results can be achieved.

However, prior to the invention, no such method has existed.

### SUMMARY OF THE INVENTION

In view of the foregoing and other problems, drawbacks, and disadvantages of the conventional methods and structures, an object of the present invention is to provide a method and structure for intelligent spellchecking which provides a much more accurate spellchecking mechanism.

Another object is to provide a method and system for intelligent spellchecking in which an entire sentence and a structure of the entire sentence are taken into consideration, in determining whether a word is misspelled or not.

In a first aspect of the present invention, a method (and system) for intelligent spellchecking, includes performing a spellchecking of a word by considering an entire sentence and a structure of the entire sentence, in determining whether the word is misspelled.

Thus, with the unique and unobvious features of the present invention, spellchecking can be performed which considers the entire sentence in which a word is formed and which also considers the structure of the entire sentence. As a result, a much more accurate spellchecking is performed.

### BRIEF DESCRIPTION OF THE DRAWINGS

The foregoing and other purposes, aspects and advantages will be better understood from the following detailed description of a preferred embodiment of the invention with reference to the drawings, in which:

FIG. 1 illustrates a functional block diagram of a system 100 according to the present invention;

FIG. 2A illustrates a flowchart of a method 200 according to the present invention;

FIG. 2B illustrates the concept of “mother ” and “daughter ” for words in a sentence;

FIG. 3 illustrates a functional block diagram of a system 300 according to the present invention;

FIG. 4 illustrates a flowchart of a method 400 according to the present invention;

FIG. 5 illustrates an exemplary information handling/computer system 500 for use with the present invention; and

FIG. 6 illustrates a storage medium 600 for storing steps of the program for the method according to the present invention.

### DETAILED DESCRIPTION OF PREFERRED EMBODIMENTS OF THE INVENTION

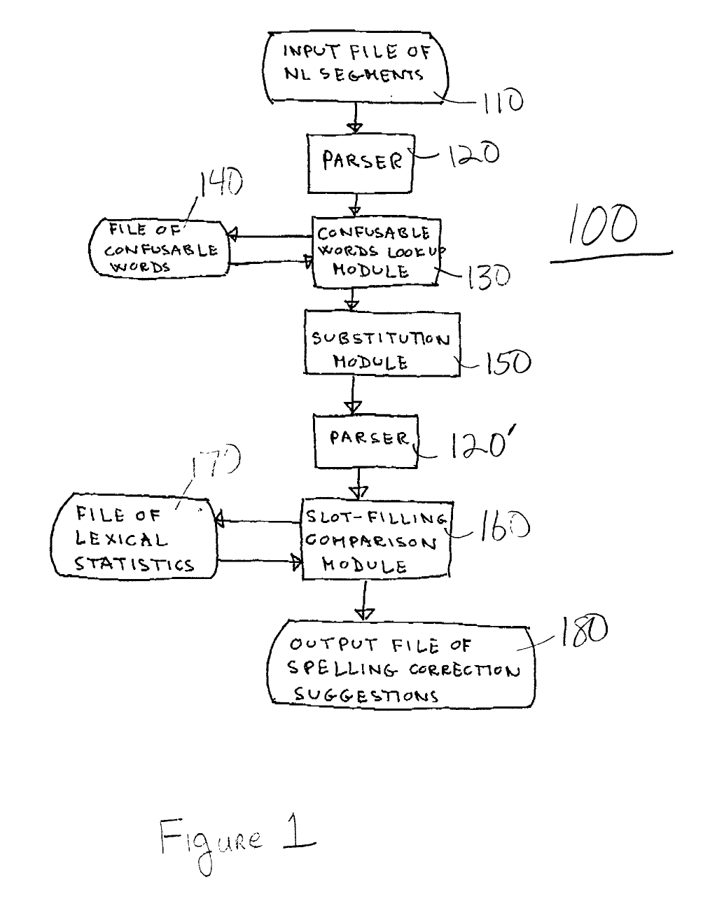

Referring now to the drawings, and more particularly to FIGS. 1-6, there are shown preferred embodiments of the method and structures according to the present invention.

As mentioned above, generally the invention provides a method and structure for intelligent spellchecking in which an entire sentence and a structure of the entire sentence are considered, in determining whether a word is misspelled.

First Preferred Embodiment

Turning now to the FIG. 1, a system 100 for intelligent spellchecking according to the present invention will be described. Again, the present invention accomplishes this by looking at a full parse.

The inventive system according to the first embodiment of the present invention includes an input unit for inputting a file of natural language segments 110, a parser 120, a confusable words lookup module 130, a file of confusable words, a substitution module 150, another parser 120′ (or alternatively the parser 120 can be used in dual functions), a slot-filling comparison module 160, a file of lexical statistics 170, and an output unit 180 for outputting a file of spelling correction suggestions.

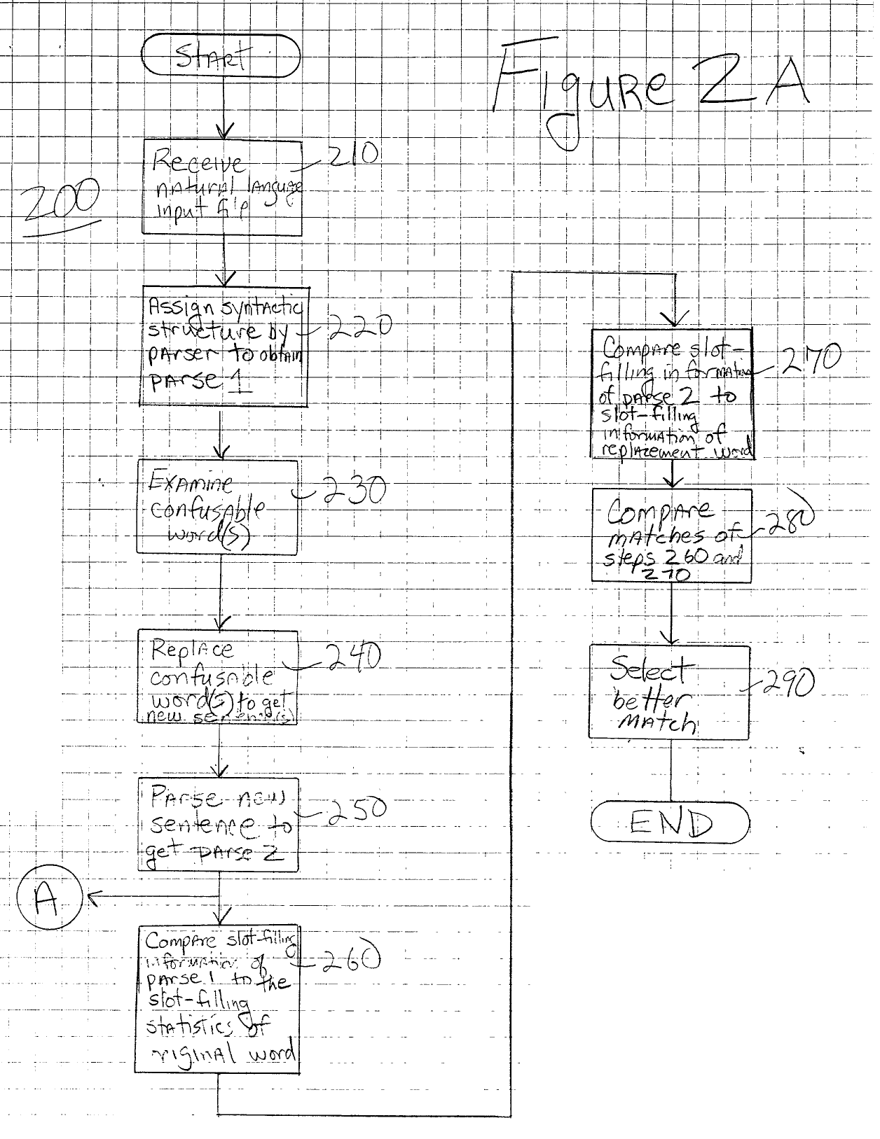

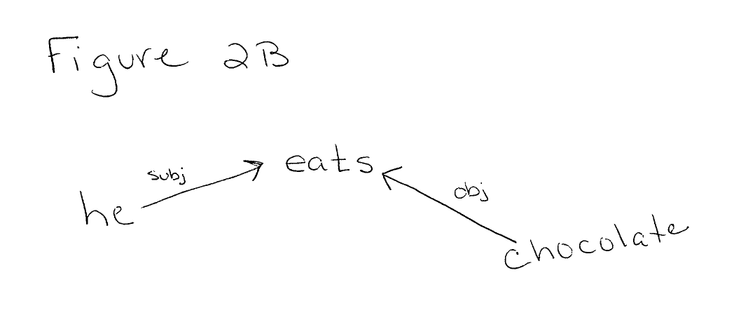

Turning to FIG. 2, a flowchart of the inventive method 200 is shown for use with the inventive system 100.

The method 200 of the first embodiment according to the present invention assumes the existence and use of a full-fledged parser 120 of English (or any other natural language), such as those described in Michael C. McCord, “Slot Grammars, Computational Linguistics, Vol. 6, pages 31-43, 1980; Michael C. McCord, “Slot Grammars: A System for Simpler Construction of Practical Natural Language Grammars, Natural Language and Logic: International Scientific Symposium, Lecture Notes in Computer Science, Springer Verlag, Berlin, pp. 118-145, 1990; and Michael C. McCord, “Heuristics for Broad-Coverage Natural Language Parsing, Proceedings of the ARPA Human Language Technology Workshop, pp. 127-132, Morgan-Kaufman, 1993, and U.S. Pat. No. 5,737,617, all incorporated herein by reference.

In step 210, such a parser 120 takes as an input a sentence written in a Natural Language such as English, and assigns a syntactic structure to it with the help of grammar rules and one or more dictionaries (step 220). This is a well-known procedure. Again, it should be noted that, as one of ordinary skill in the art would know taking the present specification as a whole, the invention is not limited to English, but indeed any natural language can be used with the invention.

The syntactic structure, henceforth referred to as a “parse ”, as a minimum contains information for each word about the word's part of speech (noun, verb, adjective etc.), its features (singular or plural, case, gender etc.) and its role (subject, object, main verb etc.). in the sentence.

The roles can be described conveniently by “slots ”. Each sense of a word by definition (in the dictionary) has a certain number of pre-defined slots. Typically, the slots are set up in advance by the designer, and are supposed to correspond to linguistic reality. The slot is determined by whether the word sense can be a verb or a noun, etc. It is also determined by, for example, what kind of verb is present. For example, as further discussed below, some verbs simply cannot take an object and therefore would not take an object slot. For some other verb of interest, it may be obligatory for this verb to take an object. In some other cases, it may be optional for the verb to take an object. Of course as is evident, most nouns do not have object slots and do not take an object. Further, while a verb may not always have an object, it will always have a subject slot. That is, the verb will always have someone/something doing something (e.g., the verb). However, sometimes a verb will not have an object associated therewith.

For example, regarding the verb “to go ”, in the phrase “I go ” the verb “go ” has a subject slot “I ”, but does not have an object slot. “I go something (e.g., object) ” would be very rarely used. One might say “I eat something ” (e.g., an object such as “food ”), but other verbs would not necessarily be used with the “something ” (e.g., an object slot). Thus, these structure types are determined by the dictionary entries.

As another example, a verb like “brush ” takes a subject and an obligatory object. “Brush ” as a noun does not have any slots. A slot may be obligatory or optional. For example, the verb “abbreviate ” requires an object, and so the object slot of “abbreviate ” is said to be obligatory.

Thus, there may be word-specific slots (e.g., verb, noun, etc.) and adjunct slots (e.g., adverbs, etc.).

A word N1 that fills a specific slot of word N2 is said to be a daughter of N2 (and conversely N2 is the mother of N1). For example, if there is a main verb (e.g., a mother), it will have a subject (daughter), and the object may be a daughter as well. In the example, “I go ”, “go ” would be the mother of “I ” (the subject) and “I ” would be a daughter of “go ”.

Thus, a given word will always have a unique mother, but can have one or more daughters.

Another example is shown in FIG. 2B. In FIG. 2B, a structure is shown for a sentence “he eats chocolate ”. The arrows point from daughter to mother, and are labeled with the slots that the daughters fill.

Thus, the totality of the slot-filling relations for the words in the sentence reflects the overall structure of the sentence.

The inventive method furthermore assumes the existence and use of a statistical dictionary that shows slot-filling statistics for a given entry (word). For example,

manager<nobj<of<10

shows that, in a given corpus, “manager ” occurred 10 times as the mother of a prepositional phrase (e.g., filling the nobj slot) with the proposition “of”. It is noted that “nobj” represents that the word at hand (e.g., manager) has a noun object. That is, to have any meaning, “manager ” must have a built in nobj slot which gives a relationship. In other words, a “manager ” (or a “spouse ”, etc.) must be a manager “of something ”.

Such a statistical dictionary can be created by a full-fledged parser such as the one described above.

Further, the inventive system assumes a dictionary of confusable words. The dictionary could be created in advance. However, all that is important is that this dictionary be present. It will most likely be created by hand (by a human). However, the invention obviously is not limited with respect to exactly how this dictionary comes into existence. An example of a confusable word may be

manger<manager

This example illustrates that “manager” is sometimes written (e.g., accidentally as a person is keying in a word while typing quickly, etc.) as “manger ”. The dictionary is referred to in which confusable words such as “manager ” are stored with their confusable counterpart (e.g., “manger ”). Most times such confusable words would be stored as doubles, but of course more words could be stored in triples, etc. For example, a likely triple would be “main ”, which could be wrongly interpreted as “Maine ” or “mane ”.

The Inventive Method

Returning now to FIG. 2A, the method 200 of the present invention will be described in detail.

First, in step 210, a natural language sentence is input. Then, in step 220, the sentence is parsed by assigning syntactic structure to the sentence, thereby to produce parse 1 (i.e., a first parse).

Then, in step 230, the list of words in the sentence are examined (e.g., by known methods such as by character recognition and comparison or the like), and any of these words that are in the list of commonly confused words are identified along with their potential replacement (e.g., their “replacement word ”).

In step 240, the confusable word(s) are replaced with their replacement word(s).

It is noted that the invention is operable with more than one confusable word per sentence. That is, the invention optimizes such a situation by replacing a first confusable word in the sentence and obtaining a new sentence. Then, a second confusable word is replaced to get another new sentence and so forth to get all possible combinations and permutations. Thus, in the case of multiple confusable words, multiple sentences are obtained and examined. All such sentences are obtained preferably prior to proceeding to the following step described below.

In step 250, the resulting sentence(s) is parsed to produce parse 2 (e.g., a second parse). The same parser as in the first parse of step 220 is preferably used. Alternatively (and less preferably), a different parser may be employed.

Then in step 260, the slot-filling information of parse 1 is compared to the slot-filling statistics for the original word. The slot filling statistics may include, as discussed above, for example, when a word such as “manager ” occurs 10 times as the noun object of “of”, and the word “manger” is encountered with “of ”, then such an occurrence may indicate a high likelihood of error since seldom will one encounter the term “manger of”.

Further, the comparison of the matches may include checking both the mother and the daughters. For the mother, it is checked whether the word fills the same slot, in the same mother word, and that this occurs a suitably high number of times according to statistics.

For the daughters, it is checked whether any obligatory slots have been filled, and preference is given to cases where all daughters are identical with respect to the slot and word for the parse and the statistics. For example, the statistical information for “manager ” might include information about a noun object slot as above, but also that this noun object slot was filled by the word “operations ” 10 times, such as:

manager<nobj<of<operations<10

Thus, if a phrase “manger of operations ” was encountered, then the substitution of “manager ” for “manger ” is supported because “manager ” occurred 10 times not only with a noun object (i.e., identical slot), but also with the specific object “operations ”. Hence, all daughters are identical.

In step 270, the slot-filling information of parse 2 (e.g., the sentence with the replacement word therein) is compared to the slot-filling statistics for the replacement word.

Finally, in step 280, the two matches (e.g., the two outputs) are compared with the slot-filling statistics found in steps 260 and 270, and in step 290 the better match is selected. The better match indicates the preferred spelling in context.

For example, the steps of 260 and 270 are the same except that one (260) is for the original word and one (270) is for the replacement word. That is, it is examined how many times the word fills the same slot. For example, in the above-mentioned situation, it is determined how many times the word “manager ” fills a same slot. Hence, it is determined that “manager” fills the same slot with the word “of” 10 times, and then it is determined how many times the word “manger ” fills the same slot (e.g., 1 time with the word “of”). Thus, 10 occurrences (e.g., for “manager ”) as opposed to one occurrence for “manger ” would indicate that “manager ” is the better choice in this context.

Conversely, in another situation, where one encounters “manger set ” 10 times as opposed to one time for “manager set ”, then this would indicate that “manger ” would be preferable in this situation.

Further, it is noted that the more statistical information regarding the sentence the better it is. Hence, the larger the number the better in examining the slot-filling information and selecting the better match. By the same token, the invention not only considers the number of times the slot has been filled, but also whether any obligatory slots exist and whether they have been actually filled, since in users' minds there is a very strong preference for filling these obligatory slots.

Thus, the invention is advantageous since it looks at the entire sentence and context with the use of the candidate word. Indeed, with the above system and method, intelligent spellchecking can be performed in which an entire sentence and a structure of the entire sentence are considered, in determining whether a word is misspelled, thereby leading to greater accuracy.

Second Embodiment

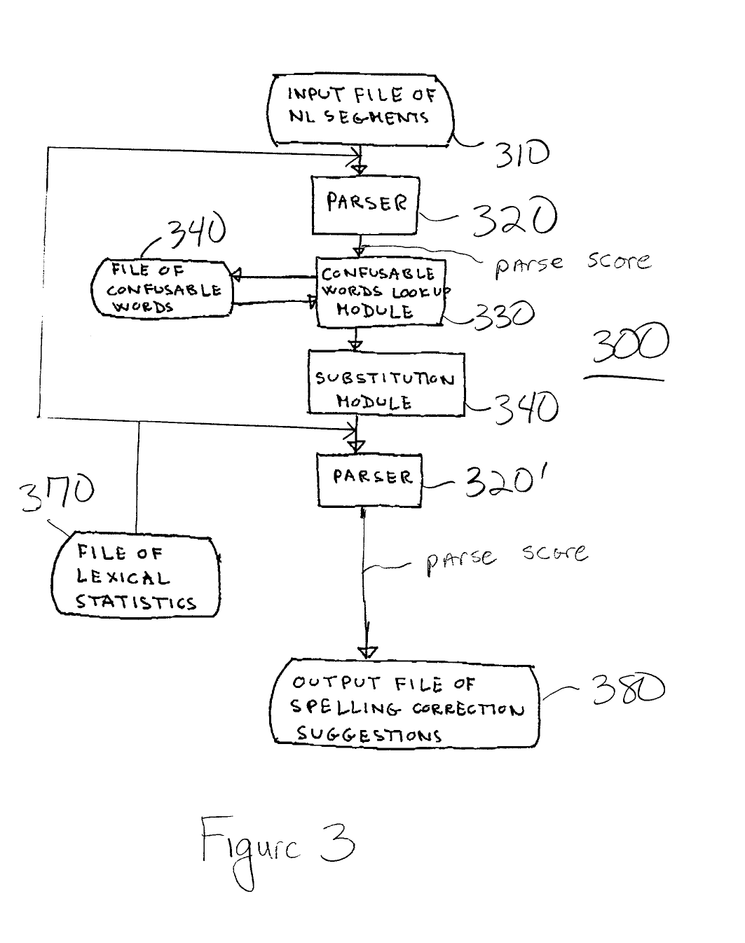

Turning to FIG. 3, a second part of the invention is a parser such as the one described above, which can automatically take the slot-filling statistics into consideration when building the parse. Furthermore, it can return a so-called “parse score ” (as described in the above mentioned article by Michael C. McCord, “Heuristics for Broad-Coverage Natural Language Parsing, Proceedings of the ARPA Human Language Technology Workshop, pp. 127-132, Morgan-Kaufman, 1993), which gives a measure of how good the parse is.

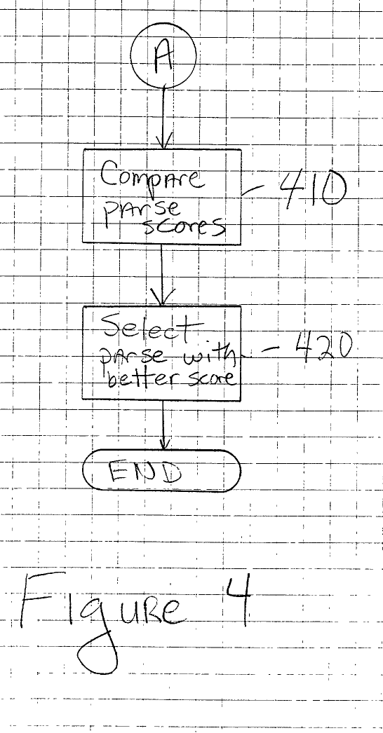

Referring to FIG. 3 (and the flowchart of FIG. 4), in this scenario, the invention operates as follows.

First, steps 210-250 of FIG. 2A are run as described above, with the parser producing a first and second parse as well as a first and second parse scores.

Then, the process proceeds to step 410, in which the parse scores are compared for the two parses. In this regard, the parser(s) in producing the first and second parses automatically considers the slot-filling statistics when building the parse and produces a first parse score.

That is, the parser in building the first parse receives an input directly from the file of lexical statistics 370 as well as the input file of the natural language segments.

Similarly, the parser in building the second parse would receive as an input an output from the substitution module 340 as well as an input directly from the file of lexical statistics 370, and produce a second parse score.

Then in step 420, the sentence with the better parse score contains the preferred spelling in context.

Thus, the invention in this aspect automatically considers the slot-filling statistics when building the parse.

While the overall methodology of the invention is described above, the invention can be embodied in any number of different types of systems and executed in any number of different ways, as would be known by one ordinarily skilled in the art.

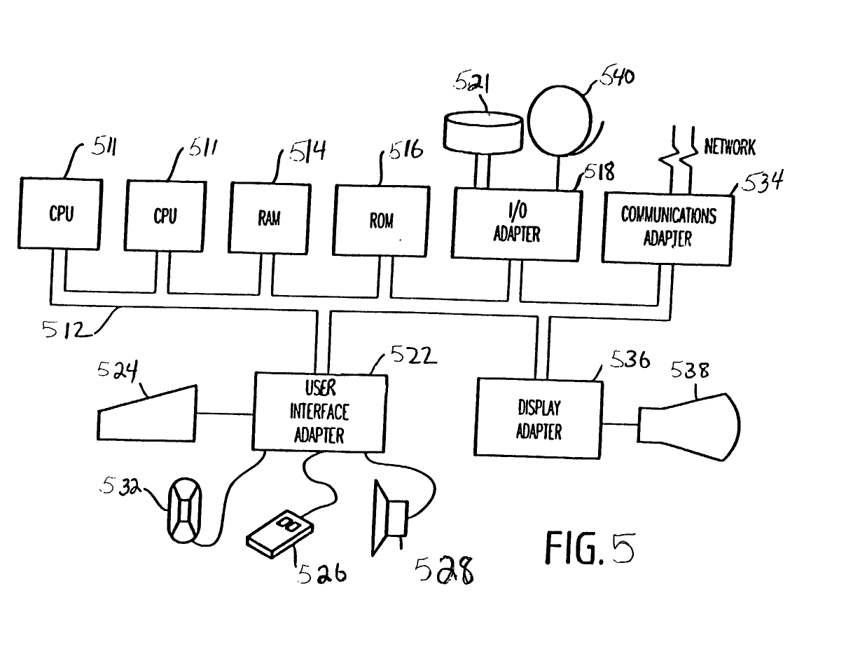

For example, as illustrated in FIG. 5, a typical hardware configuration of an information handling/computer system for use with the invention. In accordance with the invention, preferably the system has at least one processor or central processing unit (CPU) 511 and more preferably several CPUs 511. The CPUs 511 are interconnected via a system bus 512 to a random access memory (RAM) 514, read-only memory (ROM) 516, input/output (I/O) adapter 518 (for connecting peripheral devices such as disk units 521 and tape drives 540 to the bus 512), user interface adapter 522 (for connecting a keyboard 524, an input device such as a mouse, trackball, joystick, touch screen, etc. 526, speaker 528, microphone 532, and/or other user interface device to the bus 512), communication adapter 534 (for connecting the information handling system to a data processing network such as an intranet, the Internet (World-Wide-Web) etc.), and display adapter 536 (for connecting the bus 512 to a display device 538). The display device could be a cathode ray tube (CRT), liquid crystal display (LCD), etc., as well as a hard-copy printer (e.g., such as a digital printer).

In addition to the hardware/software environment described above, a different aspect of the invention includes a computer-implemented method for intelligent spellchecking. This method may be implemented in the particular environment discussed above.

Such a method may be implemented, for example, by operating the CPU 511 (FIG. 5), to execute a sequence of machine-readable instructions. These instructions may reside in various types of signal-bearing media.

Thus, this aspect of the present invention is directed to a programmed product, comprising signal-bearing media tangibly embodying a program of machine-readable instructions executable by a digital data processor incorporating the CPU 511 and hardware above, to perform the above method.

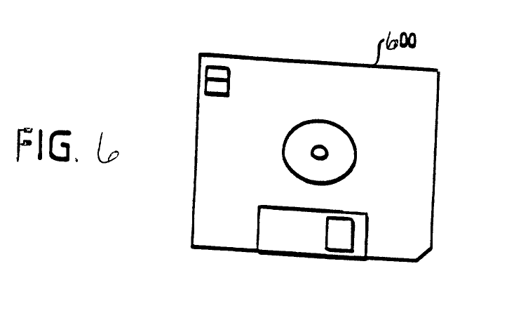

This signal-bearing media may include, for example, a RAM (not shown in FIG. 5) contained within the CPU 511 or auxiliary thereto as in RAM 514, as represented by a fast-access storage for example. Alternatively, the instructions may be contained in another signal-bearing media, such as a magnetic data storage diskette 600 (e.g., as shown in FIG. 6), directly or indirectly accessible by the CPU 511.

Whether contained in the diskette 600, the computer/CPU 511, or elsewhere, the instructions may be stored on a variety of machine-readable data storage media, such as DASD storage (e.g., a conventional “hard drive ” or a RAID array), magnetic tape, electronic read-only memory (e.g., ROM, EPROM, or EEPROM), an optical storage device (e.g. CD-ROM, WORM, DVD, digital optical tape, etc.), paper “punch ” cards, or other suitable signalbearing media including transmission media such as digital and analog and communication links and wireless. In an illustrative embodiment of the invention, the machine-readable instructions may comprise software object code, compiled from a language such as “C ”, etc.

Thus, with the unique and unobvious aspects of the present invention, a method (and system) are provided in which spellchecking can be performed which considers the entire sentence in which a word is formed and which also considers the structure of the entire sentence. As a result, a much more accurate spellchecking is performed.

While the invention has been described in terms of several preferred embodiments, those skilled in the art will recognize that the invention can be practiced with modification within the spirit and scope of the appended claims.

What is claimed is:

1. A method for intelligent spellchecking, comprising:
performing a spellchecking of a word by considering an entire sentence and a structure of the entire sentence, in determining whether the word is misspelled.

2. The method of claim 1, further comprising:
parsing the sentence to produce a first parse;
examining a list of words in the sentence and identifying a confusable original word along with its potential replacement;
replacing the confusable word with its replacement to produce a resulting sentence; and
parsing the resulting sentence to produce a second parse.

3. The method of claim 2, further comprising:
comparing slot-filling information of the first parse to slot-filling statistics for the original word.

4. The method of claim 3, further comprising:
comparing slot-filling information of the second parse to the slotfilling statistics for the replacement word.

5. The method of claim 4, further comprising:
comparing two matches with the slot-filling statistics found for the original word and the replacement word.

6. The method of claim 5, wherein a better match indicates the preferred spelling in context.

7. The method of claim 2, wherein said first and second parses produce a parse score and in determining a parse score each parse automatically considers a slot-filling statistics of the original word and the replacement word.

8. The method of claim 2, wherein a comparison of the matches includes checking both a mother designation and a daughter designation of words in said sentence.

9. The method of claim 1, wherein a decision as to which word is best depends on comparing first and second parse scores, independently of any use of lexical statistics.

10. The method of claim 1, wherein a selection of a best match for a word determined to be misspelled is performed by comparing first and second parse scores.

11. A system for intelligent spellchecking, comprising:
a spell checker for performing a spellchecking of a word by considering an entire sentence and a structure of the entire sentence, in determining whether the word is misspelled.

12. The system of claim 11, further comprising:
a parser for parsing the sentence to produce a first parse;
a detector for examining a list of words in the sentence and identifying a confusable original word along with its potential replacement; and
a replacement module for replacing the confusable word with its replacement to produce a resulting sentence,
said parser parsing the resulting sentence to produce a second parse.

13. The system of claim 12, further comprising:
a comparison module for comparing slot-filling information of the first parse to slot-filling statistics for the original word, for comparing slot-filling information of the second parse to the slot-filling statistics for the replacement word, and for comparing two matches with the slot-filling statistics found for the original word and the replacement word.

14. The system of claim 13, wherein a better match indicates the preferred spelling in context.

15. The system of claim 12, wherein said parser produces first and second parse scores and in determining a parse score each parse automatically considers a slot-filling statistics of the original word and the replacement word.

16. The system of claim 12, wherein a comparison of the matches includes checking both a mother designation and a daughter designation of words in said sentence.

17. The system of claim 11, further comprising a judgment module for making a decision as to which word is best based on comparing first and second scores, independently of any use of lexical statistics.

18. The system of claim 11, further comprising a selector for selecting a best match for a word determined to be misspelled.

19. The system of claim 11, wherein a selection of a best match for a word determined to be misspelled is performed by comparing first and second parse scores.

20. A method for intelligent spellchecking, comprising:
performing a spellchecking of a word by considering an entire sentence and a structure of the entire sentence, by performing a first and second parse to obtain a first and second parse score, in determining whether the word is misspelled.

21. The method of claim 20, wherein a decision as to which word is best depends on comparing said first and second parse scores.

22. The method of claim 21, wherein said decision is made independently of any use of lexical statistics.

23. A signal-bearing medium tangibly embodying a program of machinereadable instructions executable by a digital processing apparatus to perform a method for computer-implemented intelligent spellchecking, said method comprising:
performing a spellchecking of a word by considering an entire sentence and a structure of the entire sentence, in determining whether the word is misspelled.
